(19) United States
(12) Patent Application Publication
(10) Pub. No.: US 2025/0094680 A1
(43) Pub. Date: Mar. 20, 2025

(54) ELECTRONIC DEVICE SUPPORTING MANUFACTURE OF SEMICONDUCTOR DEVICE AND OPERATING METHOD OF ELECTRONIC DEVICE

(71) Applicant: Samsung Electronics Co., Ltd., Suwon-si (KR)

(72) Inventors: Sooyong LEE, Suwon-si (KR); Jaeyong JEONG, Suwon-si (KR)

(73) Assignee: Samsung Electronics Co., Ltd., Suwon-si (KR)

(21) Appl. No.: 18/617,946

(22) Filed: Mar. 27, 2024

(30) Foreign Application Priority Data
Sep. 19, 2023 (KR) 10-2023-0125045

(51) Int. Cl. G06F 30/392; G06F 30/398; G06F 119/18

(52) U.S. Cl. CPC G06F 30/392; G06F 30/398; G06F 2119/18

(57) ABSTRACT

Disclosed is an operating method of an electronic device which includes a processor and supports manufacture of a semiconductor device. The method includes receiving, at the processor, layout data for the manufacture of the semiconductor device, feature data of the layout data, and skew data after the semiconductor device is manufactured; inferring, at the processor, a center and a distribution of a skew of each of patterns and/or edges of the layout data based on the layout data and the feature data, by using a deep learning module; calculating, at the processor, a loss based on the center and the distribution of the skew based on the skew data, and training, at the processor, the deep learning module based on the loss, and the layout data, the feature data, and the skew data are formatted as tabular data.

### CROSS-REFERENCE TO RELATED APPLICATIONS

This application claims priority under 35 U.S.C. § 119 to Korean Patent Application No. 10-2023-0125045 filed on Sep. 19, 2023, in the Korean Intellectual Property Office, the disclosures of which are incorporated by reference herein in their entireties.

### BACKGROUND

Various example embodiments described herein relate to an electronic device, and more particularly, relate to an electronic device supporting the manufacture of a semiconductor device through learning and inference operations for inferring a skew center and/or a distribution, and/or to an operating method of the electronic device.

A semiconductor device is manufactured through various processes. With the development of semiconductor device design technologies, the number of processes for manufacturing a semiconductor device is increasing, and the complexity of each process is increasing. As the number of processes and the complexity increase, various defects may occur in the process of manufacturing a semiconductor device. The defects may deleteriously affect the yield and/or the reliability of the semiconductor device.

For example, when a specific pattern is formed, there may be a skew and/or a misalignment in that the specific pattern is located to be different from a design location. Due to the skew, patterns to be connected may be separated from each other and in some instances may lead to an open circuit, and/or patterns to be separated may be connected to each other and in some instances may lead to a short circuit. Accordingly, the skew causes a low yielding and/or low reliability semiconductor device.

### SUMMARY

Various example embodiment provide an electronic device performing learning and inference for inferring a center and a distribution of a skew, to more accurately support the manufacture of a semiconductor device, and/or an operating method of the electronic device.

According to some example embodiments, an operating method of an electronic device which includes a processor and is configured to support manufacture of a semiconductor device includes receiving, at the processor, layout data associated with the manufacture of the semiconductor device, feature data of the layout data, and skew data after the semiconductor device is manufactured, inferring, at the processor, a center and a distribution of a skew of each of patterns and/or edges of the layout data based on the layout data and on the feature data, by using a deep learning module, calculating, at the processor, a loss based on the center and the distribution of the skew based on the skew data, and training, at the processor, the deep learning module based on the loss, and the layout data, the feature data, and the skew data having a tabular data format.

Alternatively or additionally according to various example embodiments, an operating method of an electronic device which includes a processor and is configured to support manufacture of a semiconductor device includes receiving, at the processor, layout data for manufacture of a second semiconductor device and feature data of the layout data, inferring, at the processor, a center and a distribution of a skew of each of patterns and/or edges of the layout data based on the layout data and the feature data, by using a deep learning module, performing, at the processor, Monte Carlo simulation based on the center of the skew and the distribution of the skew, and modifying, at the processor, a layout image corresponding to the layout data based on a result of the Monte Carlo simulation, and the deep learning module is trained based on tabular data and knowledge distillation.

Alternatively or additionally according to various example embodiments, an electronic device for manufacture of a semiconductor device includes a processor, and a memory configured to store layout data associated with the manufacture of the semiconductor device, feature data of the layout data, and skew data after the semiconductor device is manufactured. The processor is configured to execute a deep learning module to infer a center and a distribution of a skew of each of patterns and/or edges of the layout data, based on the layout data and the feature data, to calculate a loss based on the center and the distribution of the skew and the skew data, and to train the deep learning module based on the loss. The layout data, the feature data, and the skew data have a tabular format.

### BRIEF DESCRIPTION OF THE FIGURES

The above and other objects and features of the present disclosure will become apparent by describing in detail embodiments thereof with reference to the accompanying drawings.

FIG. 1 illustrates a semiconductor manufacturing system according to some example embodiments.

FIG. 2 is a block diagram illustrating an electronic device according to some example embodiments.

FIG. 3A illustrates an example of an operating method of an electronic device.

FIG. 3B illustrates another example of an operating method of an electronic device.

FIG. 4 illustrates an example of process result data and feature data.

FIG. 5 illustrates an example of extracting an influence of neighboring patterns on a specific pattern as second feature data.

FIGS. 6 and 7 illustrate an example of extracting an influence of neighboring patterns on a specific pattern as third feature data.

FIG. 8 illustrates an example in which features are extracted from grids on a second layout image.

FIG. 9A illustrates an example of a method in which a first deep learning module performs learning.

FIG. 9B illustrates an example in which a first deep learning module is used to modify a layout image after the learning of the first deep learning module is completed.

FIG. 10 illustrates an example in which a first center inferred by a first deep learning module and an actually measured center are matched.

FIG. 11A illustrates an example of a method in which a second deep learning module performs learning.

FIG. 11B illustrates an example in which a second deep learning module is used to modify a layout image after the learning of the second deep learning module is completed.

FIG. 12 illustrates an example in which a second center inferred by a second deep learning module based on knowledge distillation moves.

FIG. 13 illustrates an example in which a simulation device and a layout generation module modify a layout image.

FIG. 14 illustrates an example in which a simulation device sets boundaries on a simulation result.

FIG. 15 illustrates an example of a center and a distribution measured based on simulation data of a simulation device and a center and a distribution actually measured from semiconductor devices.

### DETAILED DESCRIPTION

Below, some example embodiments will be described in detail and clearly to such an extent that an ordinary one in the art easily carries out the present disclosure.

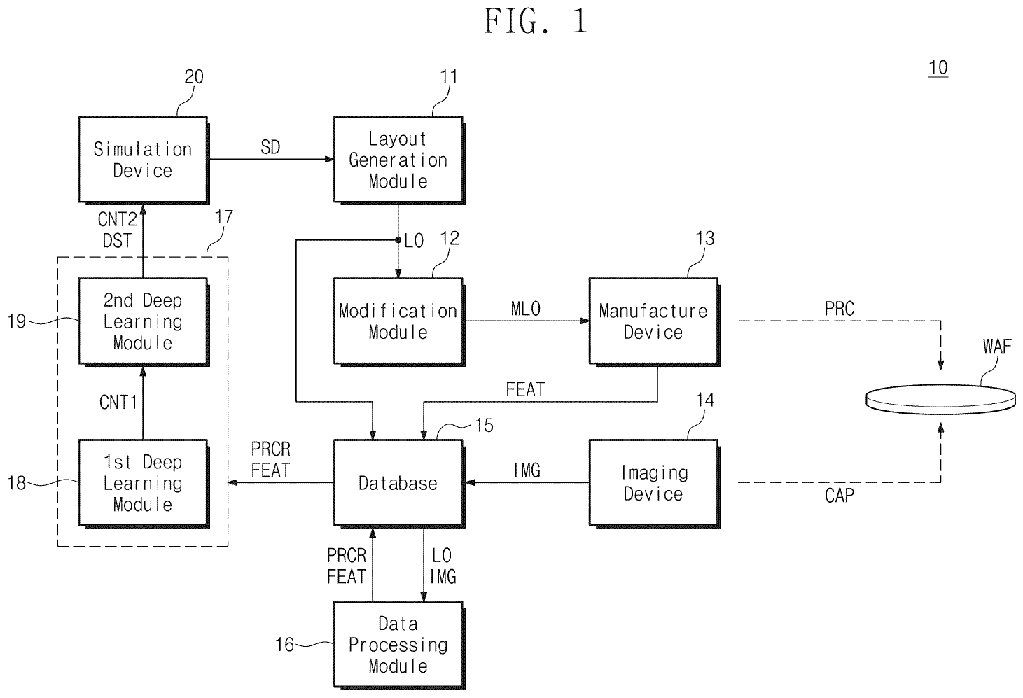

FIG. 1 illustrates a semiconductor manufacturing system 10 according to some example embodiments. Referring to FIG. 1, the semiconductor manufacturing system 10 may include at least one layout generation module 11, at least one modification module 12, at least one manufacture device 13, at least one imaging device 14, at least one database 15, at least one data processing module 16, at least one deep learning module 17, and at least one simulation device 20. The semiconductor manufacturing system 10 may manufacture semiconductor devices by using a wafer WAF.

The layout generation module 11 may generate a layout image LO. For example, the layout generation module 11 may generate and/or receive circuit-based design information. The layout generation module 11 may generate the layout image LO by placing standard cells based on the design information. Alternatively or additionally, after placing the standard cells, the layout generation module 11 may generate the layout image LO by modifying the standard cells or placing specialization cells, which are not included in the standard cells. The modification may be under control of the user. For example, the layout image LO that the layout generation module 11 generates may be or may include or be included in a design image for the manufacture of semiconductor devices and may include patterns to be generated in a semiconductor device and/or shapes of edges of the patterns.

The modification module 12 may receive the layout image LO for the manufacture of semiconductor devices from the layout generation module 11. In various example embodiments, the modification module 12 may generate a modified layout image MLO from the layout image LO. For example, under control of the user the modification module 12 may generate the modified layout image MLO from the layout image LO, based on a given algorithm, and/or based on a machine learning (or deep learning) device trained in advance.

The modification module 12 may generate the modified layout image MLO from the layout image LO to apply various factors that may be affected in the manufacture of semiconductor devices. For example, the modification module 12 may generate the modified layout image MLO based at least on a process proximity correction (PPC) and an optical proximity correction (OPC).

The process proximity correction may be used to correct distortions caused during processes (e.g., an etching process and/or a chemical mechanical planarization process and/or a deposition process) due to various factors including features of materials for performing a process, features of materials to which the process is applied, features of photoresist patterns, etc. For example, the optical proximity correction may be performed to correct or improve upon distortions caused in photoresist patterns due to various factors, which include features such as at least one of a feature of a light source, a feature of a photoresist, positional relationships between the light source and patterns formed in the photoresist, etc., in the process of generating a photomask for the manufacture of semiconductor devices. In some example embodiments, the optical proximity correction process may include adding and/or removing serifs, and/or adding other sub-resolution assist features such as but not limited to in-riggers and/or out-riggers.

The manufacture device 13 may receive the modified layout image MLO from the modification module 12. The manufacture device 13 may apply processes PRC to the wafer WAF based on the modified layout image MLO. For example, the processes PRC may include one or more of an etching process, a deposition process, a growth process, a planarization process, an implantation process, an annealing process, etc. As the processes PRC are applied to the wafer WAF, semiconductor devices may be formed in the wafer WAF. The wafer WAF may have a diameter of 200 mm, or of 300 mm, or of 450 mm; example embodiments are not limited thereto.

The imaging device 14 may generate a captured image IMG by capturing an image of the semiconductor devices formed in the wafer WAF (refer to “CAP” of FIG. 1). For example, the imaging device 14 may include a scanning electron microscope (SEM). The SEM may be or may include or be included in a critical-dimension SEM (CD-SEM); example embodiments are not limited thereto.

The database 15 may receive the layout image LO from the layout generation module 11 and may receive the captured image IMG of the semiconductor devices manufactured based on the layout image LO from the imaging device 14. The database 15 may store and manage the layout image LO and the captured image IMG in pairs (or in a correspondence relationship).

The data processing module 16 may receive the layout image LO and the captured image IMG stored in the database 15. The data processing module 16 may generate process result data PRCR and feature data FEAT based on the layout image LO and the captured image IMG. For example, the data processing module 16 may compare the layout image LO and the captured image IMG and may generate the process result data PRCR based on a difference between the layout image LO and the captured image IMG. For example, the process result data PRCR may include a misalignment and/or a skew. The skew may mean or indicate a difference between patterns on the layout image LO and patterns on the captured image IMG and/or between edges of the patterns on the layout image LO and edges of the patterns on the captured image IMG. The process result data PRCR may be or may be formatted in tabular data and/or text data.

The data processing module 16 may generate the feature data FEAT from the layout image LO and/or from the captured image IMG. The feature data FEAT may indicate features of the layout image LO or the captured image IMG. The feature data FEAT may be tabular data or text data. The data processing module 16 may store the process result data PRCR and the feature data FEAT in the database 15.

In various example embodiments, the data processing module 16 may further perform defect detection. The data processing module 16 may determine whether a defect occurs in the captured image IMG, by comparing the layout image LO and the captured image IMG. A semiconductor device corresponding to the captured image IMG where a defect is detected may be treated as a defective (or bad) product, or an underperforming or under-yielding product. A semiconductor device corresponding to the captured image IMG where a defect is not detected may be treated as a good product, or a yielding product.

The deep learning module 17 may perform learning and inference. In the learning, the deep learning module 17 may receive the process result data PRCR and the feature data FEAT from the database 15. In the learning, the deep learning module 17 may infer a second center CNT2 and a distribution DST based on the feature data FEAT and may be trained based on the process result data PRCR. For example, the second center CNT2 may indicate a center of a skew of each of the patterns of the layout image LO and/or of the captured image IMG, and/or a center of a skew of each of edges of the patterns. The distribution DST may indicate a skew distribution of each of the patterns of the layout image LO and/or the captured image IMG, and/or a skew distribution of each of the edges of the patterns.

In the inference, the deep learning module 17 may receive the feature data FEAT from the database 15. In the inference, the deep learning module 17 may infer the second center CNT2 and the distribution DST from the feature data FEAT based on a pre-trained result.

The deep learning module 17 may include a first deep learning module 18 and a second deep learning module 19. The first deep learning module 18 and the second deep learning module 19 may be based on different algorithms. The first deep learning module 18 may infer a first center CNT1 based on the feature data FEAT and may be trained based on the first center CNT1 thus inferred and the process result data PRCR. The second deep learning module 19 may infer the second center CNT2 and the distribution DST based on the first center CNT1 inferred by the first deep learning module 18 and the feature data FEAT and may be trained based on the second center CNT2, the distribution DST, the first center CNT1, and the process result data PRCR.

The simulation device 20 may receive the second center CNT2 and the distribution DST from the deep learning module 17. The simulation device 20 may perform simulation based on the second center CNT2 and the distribution DST. For example, the simulation device 20 may simulate aspects that a skew occurs in each of the patterns or in each of the skews of the patterns. The simulation device 20 may perform the simulation and may generate simulation data SD as a result of the simulation.

In various example embodiments, the simulation device 20 may not participate in the learning of the deep learning module 17. When the deep learning module 17 is used for the inference after the learning of the deep learning module 17 is completed, the simulation device 20 may perform the simulation based on the second center CNT2 and the distribution DST and may copy or replicate skews corresponding to the patterns of the layout image LO or the edges of the patterns.

The layout generation module 11 may receive the simulation data SD from the simulation device 20. The layout generation module 11 may modify the layout image LO based on the simulation data SD. For example, the layout generation module 11 may change locations of patterns with a great skew or locations of edges of the patterns, and thus, separated patterns may be prevented from or reduced in likelihood of being connected to each other (e.g., shorted), and/or connected patterns may be prevented from or reduced in likelihood of being separated from each other (e.g., opened). For example, the layout generation module 11 may modify the layout image LO, for example under control of the user, depending on a given algorithm, and/or based on a pre-trained machine learning device.

In various example embodiments, the layout generation module 11, the modification module 12, the data processing module 16, the deep learning module 17, and the simulation device 20 may be implemented with software executable by a processor, a processor designed to perform a relevant function, or a combination of hardware and software designed to perform a relevant function.

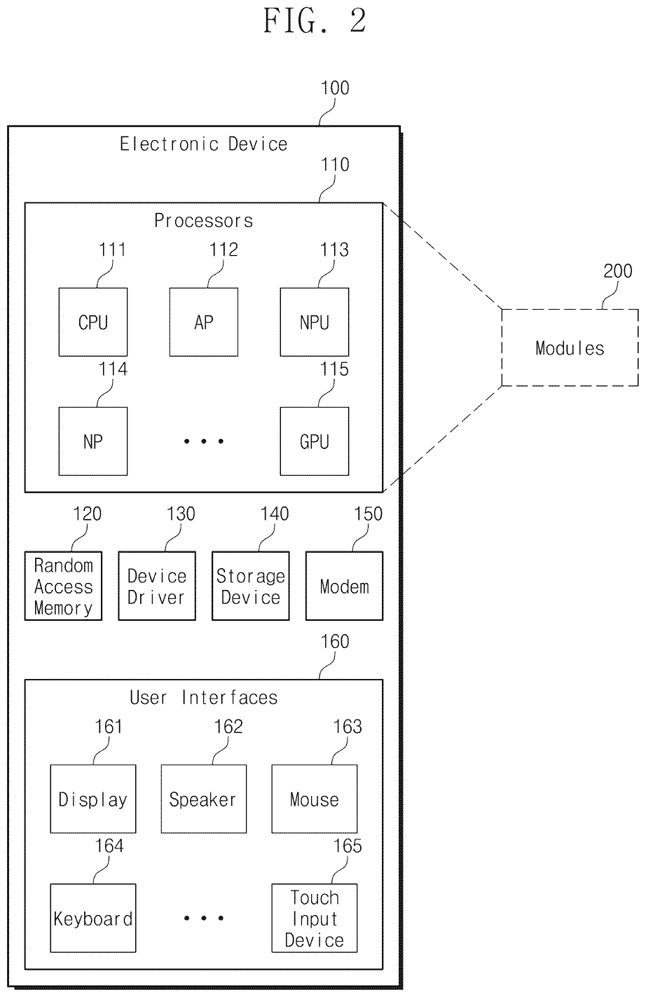

FIG. 2 is a block diagram illustrating an electronic device 100 according to some example embodiments. Referring of the FIG. 2, the electronic device 100 may be configured to support the manufacture of semiconductor devices. The electronic device 100 may perform some of functions or processes of the semiconductor manufacturing system 10 described with reference to FIG. 1. The electronic device 100 may include processors 110, a random access memory 120, a device driver 130, a storage device 140, a modem 150, and user interfaces 160.

The processors 110 may include, for example, at least one general-purpose processor such as a central processing unit (CPU) 111 or an application processor (AP) 112. Also, the processors 110 may further include at least one special-purpose processor such as a neural processing unit (NPU) 113, a neuromorphic processor (NP) 114, or a graphics processing unit (GPU) 115. The processors 110 may include two or more homogeneous processors.

At least one of the processors 110 may execute modules 200. For example, at least some of the modules 200 may include a module trained based on the machine learning or deep learning, and at least others of the modules 200 may include a module operating based on a given algorithm.

At least one of the processors 110 may be used to train the modules 200 (e.g., some associated with the learning from among the modules 200) and/or may be used to execute the trained modules 200. At least one of the processors 110 may train or execute the modules 200 based on a variety of data or information. For example, the modules 200 may be implemented in the form of instructions (or codes) that are executed by at least one of the processors 110. In this case, the at least one processor may load the instructions (or codes) of the modules 200 to the random access memory 120.

Alternatively or additionally, the at least one among the processors 110 (or at least another of the processors 110) may be manufactured to implement the modules 200. For example, the at least one processor may be a dedicated processor that is implemented in hardware based on the modules 200 generated by the learning of the modules 200.

Alternatively or additionally, the at least one among the processors 110 (or at least another of the processors 110) may be manufactured to implement various machine learning and/or deep learning modules. The at least one processor may implement the modules 200 by receiving information (e.g., instructions and/or codes) corresponding to the modules 200.

The random access memory 120 may be used as a working memory of the processors 110 and may be used as a main memory or a system memory of the electronic device 100. The random access memory 120 may include a volatile memory such as one or more of a dynamic random access memory or a static random access memory, or a nonvolatile memory such as one or more of a phase-change random access memory, a ferroelectric random access memory, a magnetic random access memory, or a resistive random access memory.

The device driver 130 may control the following peripheral devices depending on a request of the processors 110: the storage device 140, the modem 150, and the user interfaces 160. The storage device 140 may include a stationary storage device such as a hard disk drive and/or a solid state drive, and/or a removable storage device such as one or more of an external hard disk drive, an external solid state drive, or a removable memory card.

The modem 150 may provide remote communication with the external device. The modem 150 may perform wired or wireless communication with the external device. The modem 150 may communicate with the external device based on at least one of various communication schemes such as Ethernet, wireless-fidelity (Wi-Fi), long term evolution (LTE), and 5th generation (5G) mobile communication.

The user interfaces 160 may receive information from the user and may provide information to the user. The user interfaces 160 may include at least one user output interface such as a display 161 or a speaker 162, and at least one user input interface such as a mouse 163, a keyboard 164, or a touch input device 165.

The instructions (or codes) of the modules 200 may be received through the modem 150 and may be stored in the storage device 140. The instructions (or codes) of the modules 200 may be stored in a removable storage device, and the removable storage device may be connected to the electronic device 100. The instructions (or codes) of the modules 200 may be loaded to the random access memory 120 from the storage device 140 so as to be executed.

In various example embodiments, the modules 200 may include at least one of the layout generation module 11, the modification module 12, the data processing module 16, the deep learning module 17, and the simulation device 20 described with reference to FIG. 1. The layout generation module 11, the modification module 12, the data processing module 16, the deep learning module 17, and the simulation device 20 may be implemented or executed in different electronic devices. At least two of the layout generation module 11, the modification module 12, the data processing module 16, the deep learning module 17, and the simulation device 20 may be implemented or executed in one electronic device. In various example embodiments, the learning of the modules 200 and the use of the trained modules 200 may be performed in different electronic devices.

In various example embodiments, the database 15 may be implemented with the storage device 140 as a component of the electronic device 100 or may be implemented with a remote device communicating with the electronic device 100 through the modem 150.

Any or all of the elements described with reference to FIG. 2 may communicate with any or all other elements described with reference to FIG. 2. For example, any element may engage in one-way and/or two-way and/or broadcast communication with any or all other elements in FIG. 2, to transfer and/or exchange and/or receive information such as but not limited to data and/or commands, in a manner such as in a serial and/or parallel manner, via a bus such as a wireless and/or a wired bus (not illustrated). The information may be in encoded various formats, such as in an analog format and/or in a digital format.

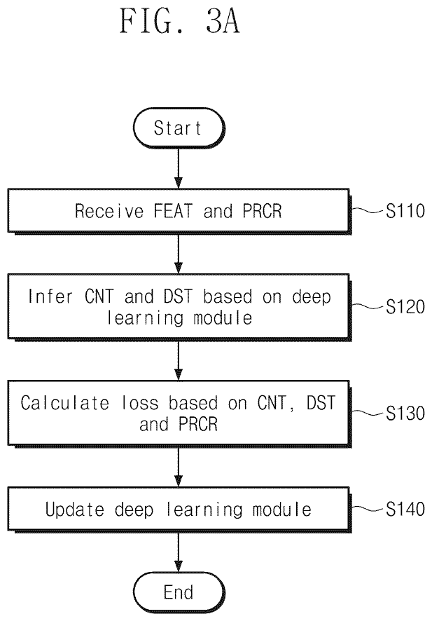

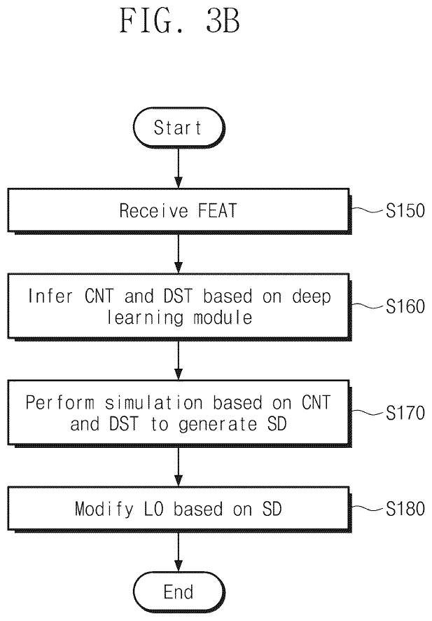

FIG. 3A illustrates an example of an operating method of the electronic device 100. In various example embodiments, an example of training the deep learning module 17 among the modules 200 executable by the processors 110 is illustrated in FIG. 3A. Referring to FIGS. 1, 2, and 3A, in operation S110, the electronic device 100 may receive the feature data FEAT and the process result data PRCR. For example, the processors 110 of the electronic device 100 may receive the feature data FEAT and the process result data PRCR from the database 15.

The feature data FEAT may be or may be formatted as tabular data and/or text data indicating the feature of the layout image LO, for example, features of the patterns of the layout image LO or features of edges of the patterns. The process result data PRCR may be or may be formatted as tabular data or text data indicating skews of patterns of a semiconductor device manufactured based on the layout image LO or skews of edges of the patterns.

In operation S120, the electronic device 100 may infer a center CNT and the distribution DST based on the deep learning module 17. For example, the center CNT may include the first center CNT1 and the second center CNT2. The deep learning module 17 may infer the first center CNT1 based on the first deep learning module 18 and may then infer the second center CNT2 based on the second deep learning module 19.

In operation S130, the electronic device 100 may calculate a loss based on the center CNT, the distribution DST, and the process result data PRCR. For example, the center CNT may include the first center CNT1 and the second center CNT2. The electronic device 100 may calculate a first loss corresponding to the first center CNT1 and may then calculate a second loss corresponding to the second center CNT2.

In operation S140, the electronic device 100 may update the deep learning module 17. For example, the electronic device 100 may independently update the first deep learning module 18 and the second deep learning module 19. The electronic device 100 may update the first deep learning module 18 based on the first loss of the first center CNT1 and may update the second deep learning module 19 based on the second loss of the distribution DST and the second center CNT2. For example, the update of the deep learning module 17 may include updating weight data of the deep learning module 17.

FIG. 3B illustrates another example of an operating method of the electronic device 100. In various example embodiments, an example of a method in which the processors 110 of the electronic device 100 modifies the layout image LO by using the deep learning module 17 trained in advance is illustrated in FIG. 3B. Referring to FIGS. 1, 2, and 3B, in operation S150, the electronic device 100 may receive the feature data FEAT. For example, the processors 110 of the electronic device 100 may receive the feature data FEAT from the database 15.

In operation S160, the electronic device 100 may infer the center CNT and the distribution DST based on the deep learning module 17. For example, the center CNT may include the first center CNT1 and the second center CNT2. The deep learning module 17 may infer the first center CNT1 based on the first deep learning module 18 and may then infer the second center CNT2 based on the second deep learning module 19.

In operation S170, the electronic device 100 may generate the simulation data SD based on the center CNT and the distribution DST. For example, the electronic device 100 may generate the simulation data SD by performing simulation based on the second center CNT2 and the distribution DST by using the simulation device 20. The simulation data SD may indicate aspects in which skews occur in the patterns of the layout image LO or edges of the patterns, based on the second center CNT2 and the distribution DST.

In operation S180, the electronic device 100 may modify the layout image LO based on the simulation data SD. For example, the electronic device 100 may change locations of patterns with a great skew or locations of edges of the patterns, and thus, separated patterns may be prevented from being connected to each other or connected patterns may be prevented from being separated from each other.

For example, the feature data FEAT may indicate features of a new layout image LO that is not yet used in the manufacture of semiconductor devices. In some examples, the electronic device 100 may in advance prevent or reduce the likelihood of and/or impact from a defect occurring by modifying the layout image LO based on the simulation data SD before a semiconductor device is manufactured by using the layout image LO.

Alternatively or additionally, the feature data FEAT may indicate features of the new layout image LO that is already used in the manufacture of semiconductor devices and whose yield is underperforming, e.g., is lower than a threshold value. In some example embodiments, after a semiconductor device is manufactured by using the layout image LO, the electronic device 100 may detect locations of defective patterns or locations of edges of the defective patterns based on the simulation data SD. The electronic device 100 may modify the patterns of the detected locations or the edges of the patterns of the detected locations, and thus, a defect may be prevented from occurring in a semiconductor device.

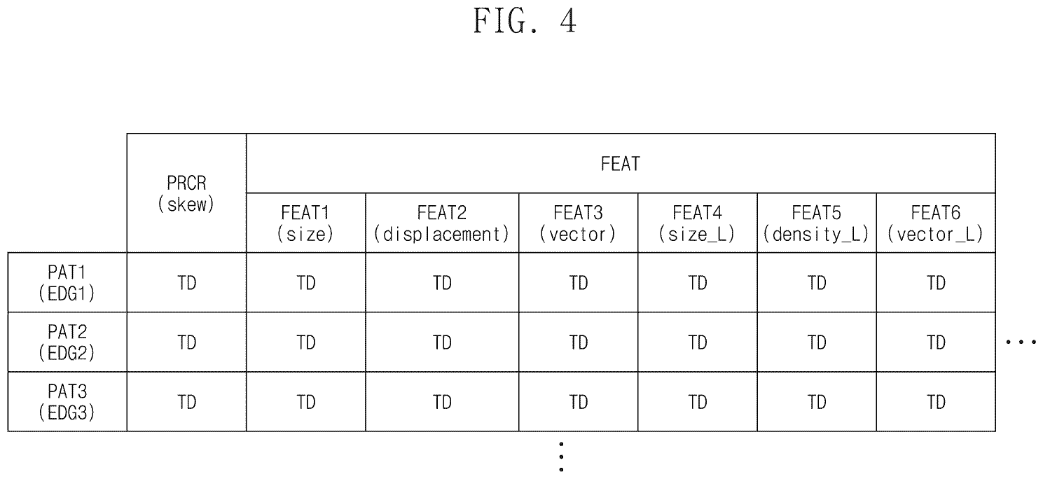

FIG. 4 illustrates an example of the process result data PRCR and the feature data FEAT. Referring to FIG. 4, the process result data PRCR may include a skew of and/or a misalignment of each of patterns, and/or a skew of and/or a misalignment of each of edges of the patterns. For example, the skew of each pattern may indicate a difference of a critical dimension (CD). The critical dimension (CD) may refer to a width of each pattern and/or to a spacing between neighboring patterns.

Alternatively or additionally, the skew of each of the edges of the patterns may refer to a difference of a bias. The difference of the bias may indicate a difference between a location of an edge of the layout image LO and a location of an edge of the captured image IMG.

In various example embodiments, the process result data PRCR may include data corresponding to a first pattern PAT1 or a first edge EDG1 of the first pattern PAT1, a second pattern PAT2 or a second edge EDG2 of the second pattern PAT2, and a third pattern PAT3 or a third edge EDG3 of the third pattern PAT3.

The feature data FEAT may include geometric features of the patterns of the layout image LO and/or of edges of the patterns. The feature data FEAT may include first feature data FEAT1, second feature data FEAT2, third feature data FEAT3, fourth feature data FEAT4, fifth feature data FEAT5, and sixth feature data FEAT6.

The first feature data FEAT1 may indicate a size. For example, the first feature data FEAT1 may indicate the size (e.g., the area and/or a width and length) of each of patterns, and/or the size (e.g., the length) of each of edges of the patterns.

The second feature data FEAT2 may indicate a displacement. For example, the second feature data FEAT2 may indicate the influence of a neighboring pattern(s) on each of patterns or the influence of an edge(s) of the neighboring pattern(s) on each of edges of the patterns.

The third feature data FEAT3 may indicate a vector. For example, the third feature data FEAT3 may indicate a sum of influences that neighboring patterns in a given region have on each of patterns or a sum of influences that the neighboring patterns in the given region have on each of edges of the patterns.

The fourth feature data FEAT4 may indicate a long-distance size size_L. For example, assuming that grids are on the layout image LO, the fourth feature data FEAT4 may indicate a sum (such as including shape information) of sizes of patterns belonging to each grid or a sum (such as including shape information) of sizes of edges of the patterns.

The fifth feature data FEAT5 may indicate a long-distance density density_L. For example, assuming that grids are on the layout image LO, the fifth feature data FEAT5 may indicate a density (or the number) of patterns belonging to each grid or a density (or the number) of edges of the patterns.

The sixth feature data FEAT6 may indicate a long-distance vector vector_L. For example, assuming that grids are on the layout image LO, the sixth feature data FEAT6 may indicate a sum of influences that patterns of neighboring grids have on each grid or a sum of influences that edges of the patterns have on each grid.

Examples of the feature data FEAT are described, but the feature data FEAT are not limited to the above example. For example, at least one new type of data may be added to the feature data FEAT, and data having at least one of the above types may be removed from the feature data FEAT. In some example embodiments, feature data FEAT may include a combination of or a function of the first to sixth features FEAT1 to FEAT6.

In various example embodiments, the feature data FEAT may include data corresponding to the first pattern PAT1 or the first edge EDG1 of the first pattern PAT1, the second pattern PAT2 or the second edge EDG2 of the second pattern PAT2, and the third pattern PAT3 or the third edge EDG3 of the third pattern PAT3.

The process result data PRCR and the feature data FEAT may be implemented in the form of or may be formatted as tabular data TD and/or text data TD. The deep learning module 17 may perform inference and learning based on the tabular data TD and/or the text data TD.

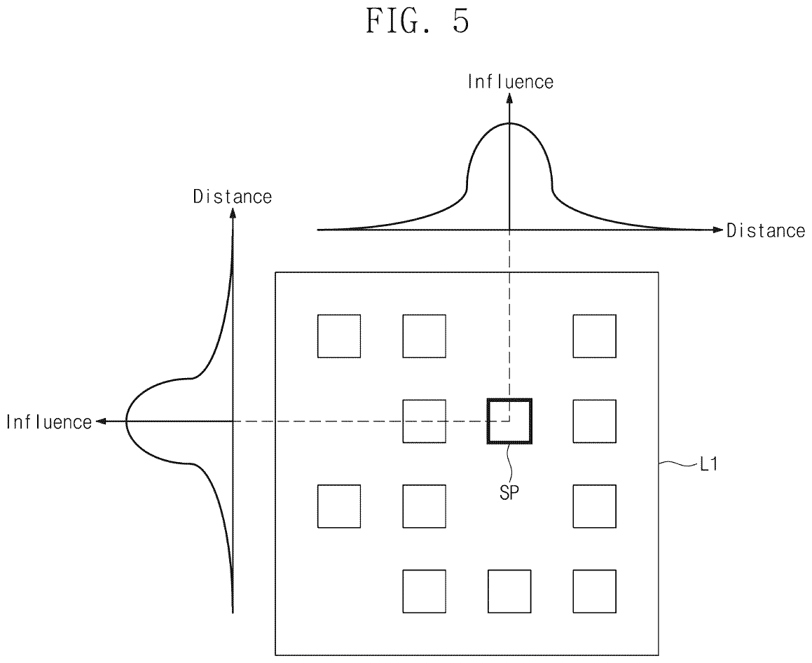

FIG. 5 illustrates an example of extracting an influence of neighboring patterns on a specific pattern (e.g., a selected pattern) as the second feature data FEAT2. Referring to FIG. 5, a selected pattern SP on a first layout image L1 is depicted by a bold line. The influence of neighboring patterns with the selected pattern SP centered, for example, the influence of patterns existing around the selected pattern SP may be extracted. For example, the influence of the neighboring patterns may be extracted based on Equation 1 below.

$$\text{?} {A}_{i} \text{?}$$

$$\text{?} \text{indicates text missing or illegible when filed}$$

In Equation 1 above, “R” represents patterns within a range. The range that is a range in which the selected pattern SP is substantially affected may be called an influence range. The size of the influence range may be smaller than the size of a layout image.

In Equation 1, “i₀” may be an identification number of the selected pattern SP. “ [symbol] ” may be a position vector of the selected pattern SP in the coordinate system of the image. “Aᵢ” may be the size (or including a shape) of the i-th pattern (i being a positive integer being 1 or more and smaller than the number of “R”). “ [symbol] ” may be a position vector of the i-th pattern in the coordinate system of the image.

In various example embodiments, the displacement of the neighboring patterns may be extracted in the form of a function of the Gaussian distribution as expressed by Equation 1 above. In Equation 1, “σ” may represent a weight of the function of the Gaussian distribution, for example, a decay. In various example embodiments, the weight of the function of the Gaussian distribution may be determined depending on process characteristics such as one or more of a temperature, a time, a pitch, a line width, a material, and a substance.

As a distance from the selected pattern SP increases, the influence of the displacement of the neighboring patterns may decrease based on the function of the Gaussian distribution. As a distance from the selected pattern SP decreases, the influence of the displacement of the neighboring patterns may increase based on the function of the Gaussian distribution. A feature of the displacement of the neighboring patterns may be extracted for each pattern.

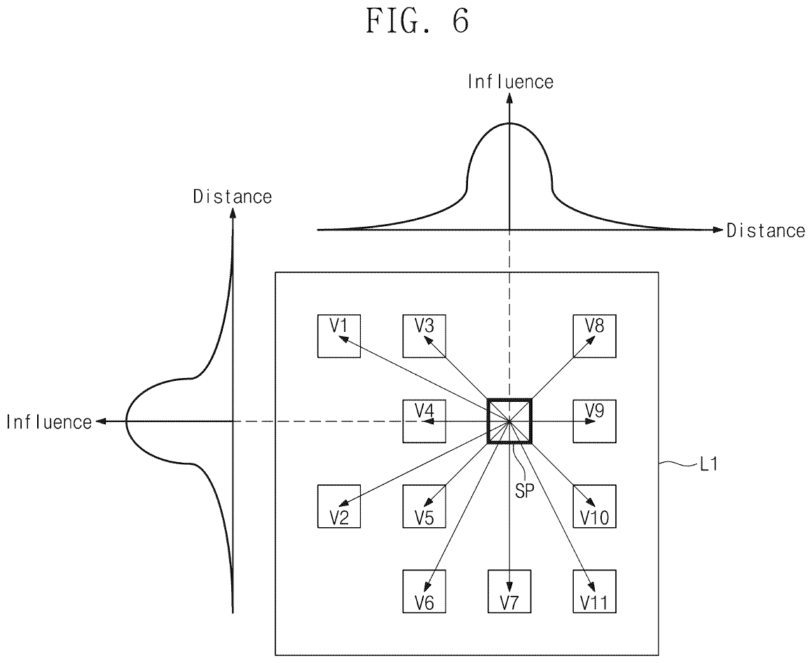

FIGS. 6 and 7 illustrate an example of extracting an influence of neighboring patterns on a specific pattern (e.g., a selected pattern) as the third feature data FEAT3. Referring to FIGS. 6 and 7, the selected pattern SP is depicted by a bold line. The influence of neighboring patterns with the selected pattern SP centered, for example, the influence of an electric field applied to the neighboring patterns in an etching process may be extracted. For example, the influence of the electric field of the neighboring patterns may be extracted based on Equation 2 below.

$${\vert \text{?} \frac{\text{?}}{\text{?}} \vert}^{2} \qquad [ Equation 2 ]$$

$$\text{?} \text{indicates text missing or illegible when filed}$$

Equation 2 may express a sum of position vectors of the neighboring patterns of the selected pattern SP, with the selected pattern SP centered. The position vectors of the neighboring patterns may be simplified to have a magnitude of “1”, and the magnitude of each position vector may be replaced with the feature of the displacement in Equation 1.

In various example embodiments, according to Equation 2, a sum of the first to eleventh position vectors V1 to V11 illustrated in FIG. 6 may be, for example, a vector “V” of FIG. 7. The magnitude of the vector “V” of FIG. 7 may be extracted as features of the influence of the electric field. The magnitude of the vector “V” may be expressed in terms of Euclidean distances; however, example embodiments are not limited thereto.

In addition, the influence that the neighboring patterns have on an etch skew of the selected pattern SP may be extracted based on Equation 3 below.

$$\vert \text{?} \qquad [ Equation 3 ]$$

$$\text{?} \text{indicates text missing or illegible when filed}$$

In Equation 3, “θ₀” may be a phase of the selected pattern SP in the coordinate system of the image, and “θᵢ” may be a phase of the i-th pattern in the coordinate system of the image. According to Equation 3 above, a feature of the influence of the skew may be extracted by performing double correction with respect to angle information of the position vectors of the neighboring patterns with the selected pattern SP centered such that the harmonics are applied to the displacement characteristic of Equation 1.

In various example embodiments, the description is given in Equation 3 as the double correction is performed with respect to the angle information, but the angle information may be corrected “m times” (m being a positive integer) depending on a process characteristic. Also, the feature of the influence of the skew may be extracted by applying the orthogonal basis function such as a Bessel function, instead of the harmonics.

In Equation 1 to Equation 3, the process of extracting features is described with reference to the polar coordinate system. However, the coordinate system on an image for extracting features is not limited to the polar coordinate system, and various coordinate systems may be used.

The features extracted based on the Equation 2 and Equation 3 may be included in the third feature data FEAT3.

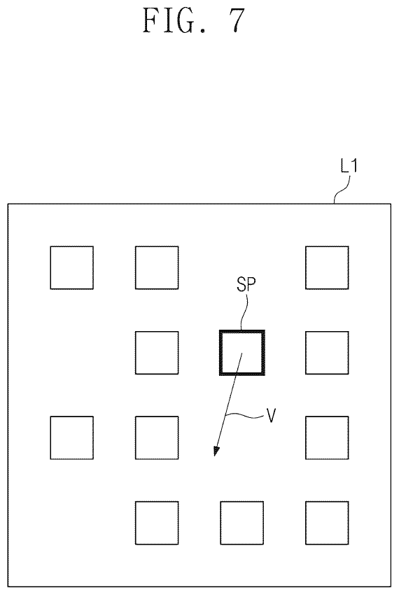

FIG. 8 illustrates an example in which features are extracted from grids on a second layout image L2. Referring to FIG. 8, a sum (which may include a shape) of sizes of patterns included in each of grids of the second layout image L2 may be extracted as the fourth feature data FEAT4. A density (or the number) of the patterns included in each of the grids may be extracted as the fifth feature data FEAT5. A vector of the patterns included in each of the grids may be extracted as the sixth feature data FEAT6. For example, a vector of the grids may be extracted by replacing the size Aᵢ with sizes of the grids or densities of the grids in Equation 1, Equation 2, or Equation 3.

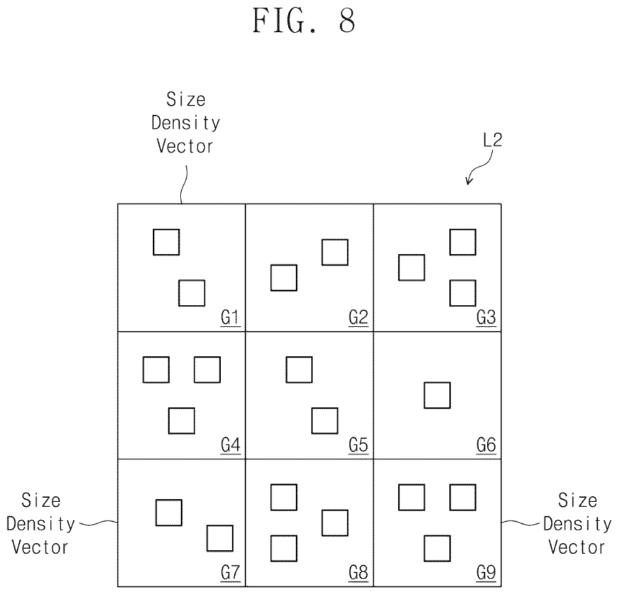

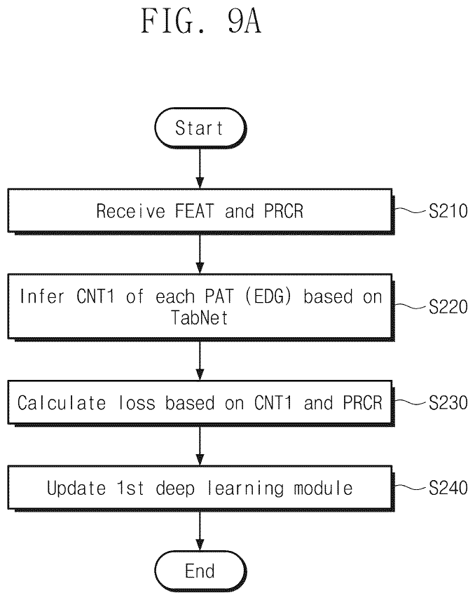

FIG. 9A illustrates an example a method in which the first deep learning module 18 performs learning. Referring to FIGS. 1, 2, and 9A, in operation S210, the first deep learning module 18 may receive the feature data FEAT and the process result data PRCR. For example, the first deep learning module 18 executed by the processors 110 of the electronic device 100 may receive the feature data FEAT and the process result data PRCR from the database 15.

In operation S220, the first deep learning module 18 may infer the first center CNT1 of each pattern PAT (or each edge EDG). For example, the first deep learning module 18 executed by the processors 110 of the electronic device 100 may infer the first center CNT1 based on the feature data FEAT, by using the TabNet. The first center CNT1 may correspond to the center of a skew distribution for each of the patterns of the layout image LO or for each of edges of the patterns.

In operation S230, the processors 110 may calculate a loss based on the first center CNT1 and the process result data PRCR. For example, the processors 110 may calculate a difference between the first center CNT1 and an actual center viewed in the process result data PRCR, as the loss. For example, the processors 110 may calculate a mean square error (MSE), a mean absolute error (MAE), or a Huber loss as the loss.

In operation S240, the processors 110 may update the first deep learning module 18. For example, the processors 110 may perform the learning of the first deep learning module 18 by updating weight data of the TabNet model of the first deep learning module 18.

In various example embodiments, the processors 110 may repeatedly perform the learning based on a plurality of different layout images LO sharing the same process PRC, and the feature data FEAT and the process result data PRCR of captured images respectively corresponding to a plurality of different layout images.

FIG. 9B illustrates an example in which the first deep learning module 18 is used to modify the layout image LO after the learning of the first deep learning module 18 is completed. Referring to FIGS. 1, 2, and 9B, in operation S250, the first deep learning module 18 may receive the feature data FEAT. For example, the first deep learning module 18 executed by the processors 110 of the electronic device 100 may receive the feature data FEAT from the database 15.

In operation S260, the first deep learning module 18 may infer the first center CNT1 of each pattern PAT (or each edge EDG) based on the TabNet. For example, the first deep learning module 18 executed by the processors 110 of the electronic device 100 may infer the first center CNT1 based on the feature data FEAT, by using the TabNet. The first center CNT1 may correspond to the center of a skew distribution for each of the patterns of the layout image LO or for each of edges of the patterns.

In operation S270, the first deep learning module 18 may output the first center CNT1. For example, the first deep learning module 18 may output the first center CNT1 to the second deep learning module 19.

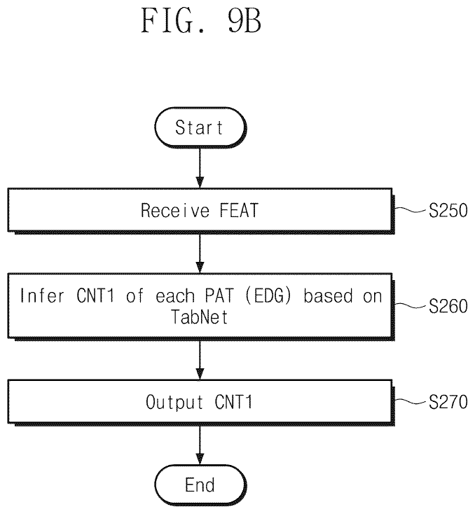

FIG. 10 illustrates an example in which a first center inferred by the first deep learning module 18 and an actually measured center are matched. In FIG. 10, a horizontal axis represents a measured skew MS, and a vertical axis represents a predicted skew PS. In FIG. 10, a solid line indicates the first center CNT1 inferred by the first deep learning module 18, and dots indicate actually measured skews. The solid line may indicate a curve or a line of best fit.

FIG. 10 shows that the first center CNT1 inferred by the first deep learning module 18 corresponds to the trend line of the actually measured skew MS. A way to infer the center from the tabular data or the text data by using the TabNet may provide a high matching characteristic. In various example embodiments, an example in which the TabNet is used as the first deep learning module 18 is described, but a kind of a deep learning model of the first deep learning module 18 is not limited thereto. For example, the first deep learning module 18 may alternatively or additionally use any other deep learning model using the tabular data and/or the text data as an input.

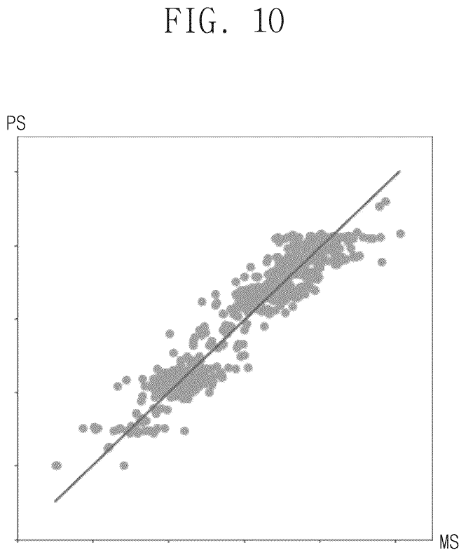

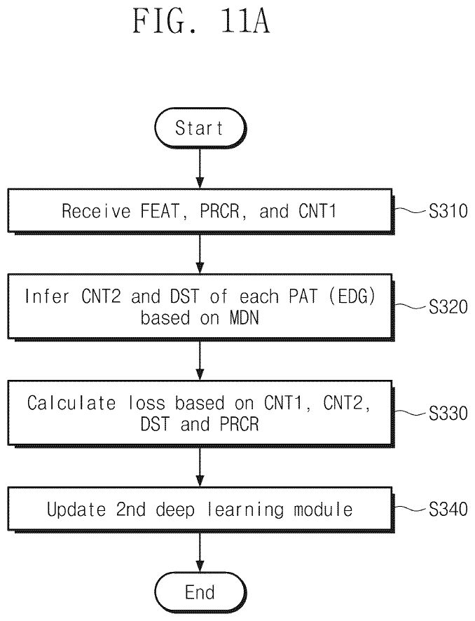

FIG. 11A illustrates an example of a method in which the second deep learning module 19 performs learning. Referring to FIGS. 1 and 11A, in operation S310, the second deep learning module 19 may receive the feature data FEAT, the process result data PRCR, and the first center CNT1. For example, the second deep learning module 19 executed by the processors 110 of the electronic device 100 may receive the feature data FEAT and the process result data PRCR from the database 15 and may receive the first center CNT1 from the first deep learning module 18. As another example, the first center CNT1 inferred by using the first deep learning module 18 may be stored in the database 15. The second deep learning module 19 may receive the feature data FEAT, the process result data PRCR, and the first center CNT1 from the database 15.

In operation S320, the second deep learning module 19 may infer the second center CNT2 and the distribution DST of each pattern PAT (or each edge EDG) based on a mixture density network (MDN). For example, the second deep learning module 19 executed by the processors 110 of the electronic device 100 may infer the second center CNT2 and the distribution DST based on the feature data FEAT and the first center CNT1, by using the MDN. The second center CNT2 may correspond to the center of a skew distribution for each of the patterns of the layout image LO or for each of edges of the patterns. The distribution DST may correspond to a distribution of skews that occur at each of patterns of the layout image LO or at each of edges of the patterns.

In operation S330, the processors 110 may calculate a loss based on the second center CNT2, the distribution DST, the first center CNT1, and the process result data PRCR. For example, the processors 110 may calculate a difference between the first center CNT1 and the second center CNT2 as a portion of the loss. In various example embodiments, the processors 110 may calculate at least one of the MSE, MAE, or Huber loss as a portion of the loss. For example, the processors 110 may calculate the loss of the second center CNT2 based on Equation 4 below.

$$Loss = \frac{1}{n} {( CNT 1 - CNT 2 )}^{2} \qquad [ Equation 4 ]$$

In Equation 4 above, “n” may represent the number of skew values of each pattern used in learning or the number of skew values of each edge, that is, a parameter. Because the loss of the second deep learning module 19 is calculated based on the inference result of the first deep learning module 18, the second deep learning module 19 may be a student module that is provided with knowledge distillation (KD) at least partially from the first deep learning module 18. The first deep learning module 18 may be teacher module that at least partially provides the knowledge distillation to the second deep learning module 19.

The processors 110 may calculate a difference between the distribution DST and a distribution of actual skews viewed in the process result data PRCR as a portion of the loss. For example, the processors 110 may calculate a negative log likelihood (NLL) as the loss. The processors 110 may calculate the NLL based on Equation 5 below.

$$NLL = \text{?} log ( \text{?} ( \text{?} \vert \text{?} ) ) = \text{?} log ( \text{?} ( \text{?} \times \text{?} ( \text{?} ) ) ) \qquad [ Equation 5 ]$$

$$\text{?} \text{indicates text missing or illegible when filed}$$

In various example embodiments, the MDN may be based on a combination of a plurality of Gaussian functions. The plurality of Gaussian functions may have different centers, different distributions, and different weights. In Equation 5 above, “j” may represent Gaussian functions, “Π” may represent a weight of each Gaussian function, “μ” may represent the center of each Gaussian function, “σ” may represent a distribution of each Gaussian function, and DST may be a distribution of the process result data PRCR.

In various example embodiments, to prevent overfitting, the processors 110 may apply minimum clamping (e.g., 1e⁻³) to “σ” and “Π”. Also, based on the L2 regularizer, the processors 110 may multiply parameters (e.g., weight parameters) and a specific small value (e.g., 1e⁻³) together and may add a multiplication result to the loss, and thus, the parameters may be prevented from becoming greater.

In operation S340, the processors 110 may update the second deep learning module 19. For example, the processors 110 may perform the learning of the second deep learning module 19 by updating weight data of the MDN model of the second deep learning module 19.

In various example embodiments, the processors 110 may repeatedly perform the learning based on a plurality of different layout images LO sharing the same process PRC, and the feature data FEAT and the process result data PRCR of captured images respectively corresponding to a plurality of different layout images.

In various example embodiments, the MDN may extract a distribution with high accuracy from the tabular data or the text data. However, the accuracy of the center that the MDN extracts from the tabular data or the text data may be relatively low. The MDN may extract the second center CNT2 and the distribution DST with high accuracy based on the knowledge distillation of the TabNet extracting the center with high accuracy.

FIG. 11B illustrates an example in which the second deep learning module 19 is used to modify the layout image LO after the learning of the second deep learning module 19 is completed. Referring to FIGS. 1, 2, and 11B, in operation S350, the second deep learning module 19 may receive the feature data FEAT and the first center CNT. For example, the second deep learning module 19 executed by the processors 110 of the electronic device 100 may receive the feature data FEAT from the database 15 and may receive the first center CNT1 from the first deep learning module 18.

In operation S360, the second deep learning module 19 may infer the second center CNT2 and the distribution DST of each pattern PAT (or each edge EDG) based on the MDN. For example, the second deep learning module 19 executed by the processors 110 of the electronic device 100 may infer the second center CNT2 and the distribution DST based on the feature data FEAT and the first center CNT1, by using the MDN. The second center CNT2 may correspond to the center of a skew distribution for each of the patterns of the layout image LO or for each of edges of the patterns. The distribution DST may correspond to a distribution of skews that occur at each of patterns of the layout image LO or at each of edges of the patterns.

In operation S370, the second deep learning module 19 may output the second center CNT2 and the distribution DST. For example, the second deep learning module 19 executed by the processors 110 of the electronic device 100 may output the second center CNT2 and the distribution DST to the simulation device 20.

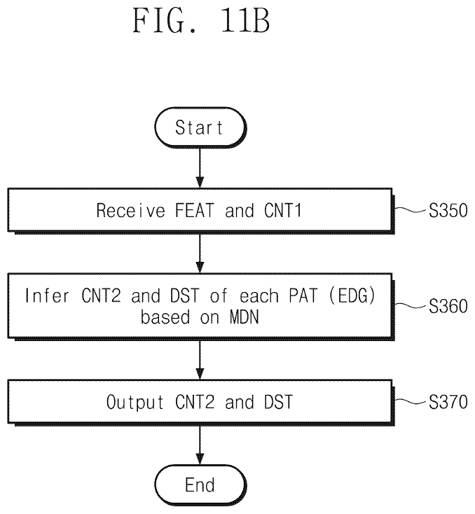

FIG. 12 illustrates an example in which the second center CNT2 inferred by the second deep learning module 19 based on knowledge distillation moves. In FIG. 12, a horizontal axis represents a location of an edge (or a critical dimension (CD) of a pattern), and a vertical axis represents a probability.

Referring to FIGS. 1 and 12, the second deep learning module 19 may infer a first skew distribution SKD1 corresponding to the second center CNT2. The first deep learning module 18 may infer the first center CNT1. The second deep learning module 19 may be trained based on the knowledge distillation KD so as to infer the first center CNT1 or infer a center close to the first center CNT1, e.g., is less than a threshold distance away from the first center CNT1. The second deep learning module 19 may be trained based on the knowledge distillation KD so as to infer a second skew distribution SKD2 corresponding to the first center CNT1.

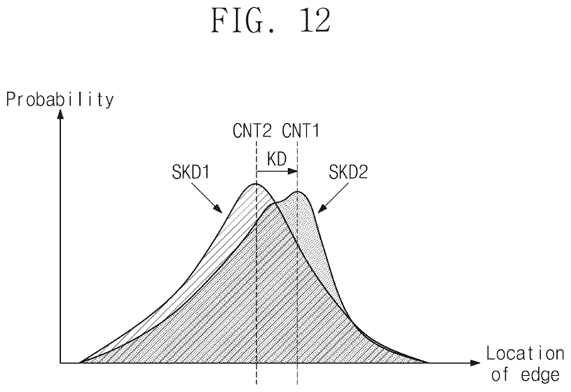

FIG. 13 illustrates an example in which the simulation device 20 and the layout generation module 11 modify the layout image LO. Referring to FIGS. 1 and 13, in operation S410, the simulation device 20 may receive the second center CNT2 and the distribution DST. For example, the simulation device 20 executed by the processors 110 of the electronic device 100 may receive the second center CNT2 and the distribution DST from the deep learning module 17.

In operation S420, the simulation device 20 may perform Monte Carlo simulation. For example, the simulation device 20 executed by the processors 110 of the electronic device 100 may copy (or replicate) aspects of skews capable of occurring at each pattern or each edge, based on the second center CNT2 and the distribution DST. To make the accuracy of the copy (or replication) high, the simulation device 20 may perform the simulation at least 100,000 times.

In operation S430, the simulation device 20 may set boundaries. For example, the simulation device 20 executed by the processors 110 of the electronic device 100 may set an upper limit and a lower limit with respect to a result of the simulation. The simulation device 20 may output simulation results having skews lower than the upper limit and greater than the lower limit, as the simulation data SD.

In operation S440, the layout generation module 11 may modify the layout image LO. For example, the processors 110 may measure a center and a distribution based on the simulation results. The layout generation module 11 may identify aspects of skews caused at patterns or edges of the layout image LO, based on the measured center and distribution.

For example, the layout generation module 11 executed by the processors 110 of the electronic device 100 may change locations of patterns with a great skew or locations of edges of the patterns, and thus, separated patterns may be prevented from being connected to each other or connected patterns may be prevented from being separated from each other. For example, the layout generation module 11 may modify the layout image LO under control of the user, depending on a given algorithm, or based on a pre-trained machine learning device.

In operation S450, the layout generation module 11 may output the modified layout image LO. For example, the layout generation module 11 executed by the processors 110 of the electronic device 100 may output the modified layout image LO to the modification module 12. The modified layout image LO may be used for the manufacture device 13 to manufacture semiconductor devices by using the wafer WAF.

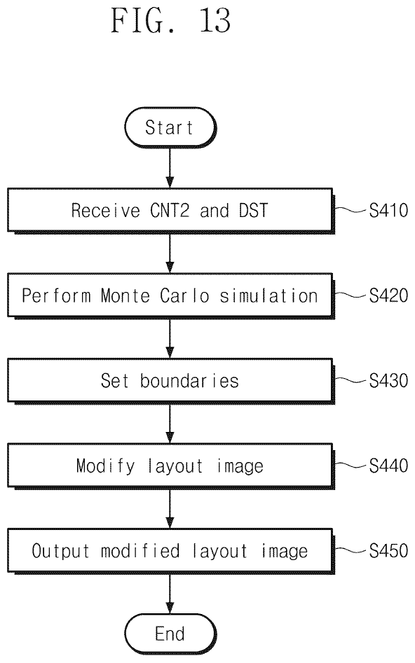

FIG. 14 illustrates an example in which the simulation device 20 sets boundaries on a simulation result. In FIG. 14, a vertical axis represents a location of an edge (or a critical dimension (CD) of a pattern), and a vertical axis represents a probability.

Referring to FIGS. 1 and 14, the simulation device 20 executed by the processors 110 of the electronic device 100 may set an upper limit UL and a lower limit LL on a skew distribution diagram. For example, the simulation device 20 may set the upper limit UL and the lower limit LL based on 3σ, 6σ, or an arbitrary given ratio or value. The simulation device 20 may discard simulation results greater than or equal to the upper limit UL and simulation results smaller than or equal to the lower limit LL. The simulation device 20 may output simulation results smaller than the upper limit UL and simulation results greater than the lower limit LL.

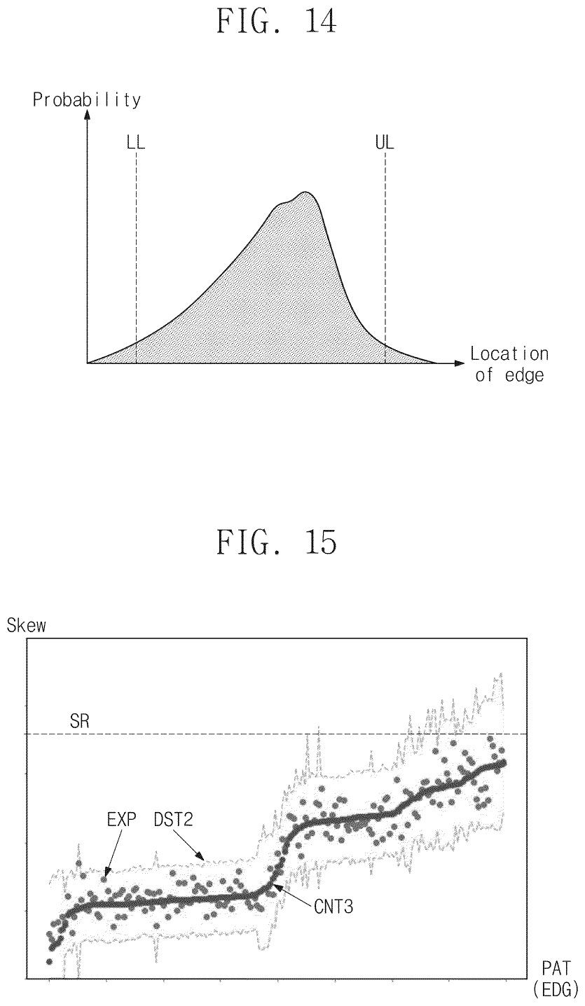

FIG. 15 illustrates an example of a center and a distribution measured based on the simulation data SD of the simulation device 20 and a center and a distribution actually measured from semiconductor devices. In FIG. 15, a horizontal axis represents patterns PAT or edges EDG of the layout image LO, and a vertical axis represents a skew.

Referring to FIGS. 1 and 15, a third center CNT3 may indicate a center of skews measured from the simulation data SD. A second distribution DST2 may indicate a distribution of the skews measured from the simulation data SD. An experimental value EXP may indicate skews measured from an actually manufactured semiconductor device. In various example embodiments, FIG. 15 may be based on absolute values of skews.

In FIG. 15, the experimental value EXP is shown as being appropriately matched with the third center CNT3 and the second distribution DST2. That is, the second center CNT2 and the distribution DST that the deep learning module 17 infers from the feature data FEAT and the third center CNT3 and the second center CNT2 that the simulation device 20 measures from the second center CNT2 and the distribution DST through the simulation may appropriately predict the experimental value EXP.

In various example embodiments, a learning model that performs inference may have uncertainty. The uncertainty may occur due to an aleatoric cause and an epistemic cause. The aleatoric cause may be based on insufficient learning and/or insufficient learning data and may be identified by increasing the learning or the learning data. The aleatoric cause may allow the learning model to generate the same outputs with respect to the same inputs.

The epistemic cause may come from a distribution of data itself. The epistemic cause may allow the learning model to generate different outputs with respect to the same inputs.

A process distribution such as a skew mainly comes from the epistemic cause. The deep learning module 17 according to various example embodiments may draw centers and distributions from all the patterns or edges of the layout image LO. Because a center and a distribution of a skew of an individual pattern or edge are drawn, the deep learning module 17 may reflect both the aleatoric cause and the epistemic cause to infer the second center CNT2 and the distribution DST.

In various example embodiments, the layout generation module 11 may set a skew limit SR. Patterns or edges with skews exceeding the skew limit SR may be determined as having a high probability of causing a defect. The layout generation module 11 may modify patterns or edges with skews exceeding the skew limit SR in the layout image LO.

For example, the layout generation module 11 may output, to the user, a message requesting the modification of the patterns or edges with skews exceeding the skew limit SR. Alternatively, depending on a given algorithm or based on a pre-trained deep learning module, the layout generation module 11 may modify the patterns or edges with skews exceeding the skew limit SR.

In the above example embodiments, components are described by using the terms “first”, “second”, “third”, etc. However, the terms “first”, “second”, “third”, etc. may be used to distinguish components from each other and do not limit the present disclosure. For example, the terms “first”, “second”, “third”, etc. do not involve an order or a numerical meaning of any form.

In the above example embodiments, components according to embodiments of the present disclosure are referenced by using blocks. The blocks may be implemented with various hardware devices, such as one or more of an integrated circuit, an application specific IC (ASIC), a field programmable gate array (FPGA), and a complex programmable logic device (CPLD), firmware driven in hardware devices, software such as an application, or a combination of a hardware device and software. Also, the blocks may include circuits implemented with semiconductor elements in an integrated circuit, or circuits enrolled as an intellectual property (IP).

According to various example embodiments, a first center may be inferred by a first deep learning module, and a second center and a distribution may be inferred by a second deep learning module. The second deep learning module may be trained by knowledge distillation that is based on the first center of the first deep learning module. Accordingly, an electronic device performing learning and inference for inferring a center and a distribution with improved accuracy and supporting the manufacture of a semiconductor device and an operating method of the electronic device are provided.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

While various example embodiments have been described with reference to embodiments thereof, it will be apparent to those of ordinary skill in the art that various changes and modifications may be made thereto without departing from the spirit and scope of the present disclosure as set forth in the following claims. Additionally example embodiments are not necessarily mutually exclusive with one another. For example, some example embodiments may include one or more features described with reference to one or more figures, and may also include one or more other features described with reference to one or more other figures.

What is claimed is:

1. An operating method of an electronic device which includes a processor and is configured to support manufacture of a semiconductor device, the method comprising:
receiving, at the processor, layout data associated with the manufacture of the semiconductor device, feature data of the layout data, and skew data obtained after at least one other semiconductor device is manufactured;
inferring, at the processor, a center of a skew and a distribution of the skew of each of patterns and/or edges of the layout data, the inferring based on the layout data and the feature data, by using a deep learning module;
calculating, at the processor, a loss based on the center of the skew and the distribution of the skew, the calculating based on the skew data; and
training, at the processor, the deep learning module based on the loss,
wherein the layout data, the feature data, and the skew data have a tabular format.

2. The method of claim 1, wherein the feature data include a size of each of the patterns, a size of each of the edges, or both a size of each of patterns and each of the edges.

3. The method of claim 1, wherein the feature data include a displacement of neighboring patterns, neighboring edges, or both neighboring patterns and neighboring edges for each of the patterns of the layout data, the edges of the layout data, or both the patterns and the edges of the layout data.

4. The method of claim 1, wherein the feature data include a vector of an influence that neighboring patterns, neighboring edges, or both neighboring patterns and neighboring edges, have on each of the patterns, the edges, or both the patterns and edges of the layout data.

5. The method of claim 1, wherein the feature data include sizes of patterns and/or edges included in a specific region of the layout data.

6. The method of claim 1, wherein the feature data include a density of patterns or edges included in a specific region of the layout data.

7. The method of claim 1, wherein the feature data include a vector of an influence that patterns or edges included in a neighboring region have on a specific region of the layout data.

8. The method of claim 1, wherein the deep learning module includes a first deep learning module and a second deep learning module, and
wherein the inferring includes:
inferring a first center of the skew by using the first deep learning module; and
inferring a second center of the skew and the distribution of the skew by using the second deep learning module.

9. The method of claim 8, wherein the calculating of the loss includes,
calculating a first loss based on the first center of the skew and on the skew data, and
wherein the training includes,
training the first deep learning module based on the first loss.

10. The method of claim 9, wherein the calculating of the loss further includes,
calculating a second loss based on the first center of the skew, the second center of the skew, the distribution of the skew, and the skew data, and
wherein the training further includes,
training the second deep learning module based on the second loss.

11. The method of claim 10, wherein the second deep learning module is trained based on knowledge distillation of the first center of the skew.

12. The method of claim 1, further comprising:
receiving, at the processor, second layout data associated with the manufacture of a second semiconductor device and second feature data of the second layout data;
inferring, at the processor, a second center and a second distribution of a second skew of each of patterns of the second layout data, edges of the second layout data, or both patterns and edges of the second layout data, based on the second layout data and the second feature data, by using the deep learning module;
performing, at the processor, Monte Carlo simulation based on the second center of the second skew and on the second distribution of the second skew; and
modifying, at the processor, a layout image corresponding to the layout data based on a result of the Monte Carlo simulation.

13. An operating method of an electronic device which includes a processor and is configured to support manufacture of a semiconductor device, the method comprising:
receiving, at the processor, layout data for manufacture of a second semiconductor device and feature data of the layout data;
inferring, at the processor, a center and a distribution of a skew of each of patterns or edges of the layout data based on the layout data and the feature data, by using a deep learning module;
performing, at the processor, Monte Carlo simulation based on the center of the skew and on the distribution of the skew; and
modifying, at the processor, a layout image corresponding to the layout data based on a result of the Monte Carlo simulation,
wherein the deep learning module is trained based on tabular data and on knowledge distillation.

14. The method of claim 13, further comprising:
transmitting the modified layout image to a manufacture device associated with the manufacture of the semiconductor device.

15. The method of claim 13, wherein the deep learning module includes a first deep learning module and a second deep learning module, and
wherein the inferring includes:
inferring a first center of the skew based on the layout data and the feature data, by using the first deep learning module; and
inferring a second center of the skew and the distribution of the skew based on the first center, the layout data, and the feature data, by using the second deep learning module.

16. The method of claim 15, wherein the second deep learning module is trained based on the knowledge distillation such that the second center is close to the first center.

17. The method of claim 15, further comprising:
setting an upper limit and a lower limit with respect to the result of the Monte Carlo simulation.

18. The method of claim 15, wherein the first deep learning module includes a TabNet, and
wherein the second deep learning module includes a mixture density network (MDN).

19. The method of claim 13, wherein the feature data include at least two of:
a size of each of the patterns or the edges;
a displacement of neighboring patterns or edges for each of the patterns or the edges;
a vector of an influence which the neighboring patterns or edges have on each of the patterns or the edges;
sizes of patterns or edges included in a specific region of the layout data;
a density of the patterns or the edges included in the specific region of the layout data; and
a vector of an influence which patterns or edges included in a neighboring region have on the specific region of the layout data.

20. An electronic device for manufacture of a semiconductor device, comprising:
a processor; and
a memory configured to store layout data associated with the manufacture of the semiconductor device, feature data of the layout data, and skew data after the semiconductor device is manufactured,
wherein the processor is configured to execute a deep learning module to,
infer a center and a distribution of a skew of each of patterns of the layout data, edges of the layout data, or both patterns and edges of the layout data, based on the layout data and the feature data,
calculate a loss based on the center and the distribution of the skew and the skew data, and
train the deep learning module based on the loss, and
wherein the layout data, the feature data, and the skew data have a tabular format.
